(19) United States
(12) Patent Application Publication
(10) Pub. No.: US 2024/0095617 A1
(43) Pub. Date: Mar. 21, 2024

(54) SECURITY MECHANISMS FOR SKILL SQUATTING

(71) Applicant: Capital One Services, LLC, Mclean, VA (US)

(72) Inventors: Joshua EDWARDS, Philadelphia, PA (US); Andrea MONTEALEGRE, Arlington, VA (US); Salik SHAH, Washington, DC (US)

(73) Assignee: Capital One Services, LLC, McLean, VA (US)

(21) Appl. No.: 17/949,463

(22) Filed: Sep. 21, 2022

(51) Int. Cl. G06Q 10/06

(52) U.S. Cl. CPC G06Q 10/063112

(57) ABSTRACT

Disclosed herein are system, method, and computer program product embodiments for protecting a device from skill squatting by verifying the legitimacy of a skill to a user before operating the skill based on user instructions. Upon receiving an audio signal from a user to operate a skill on a device, the skill can retrieve unique and non-confidential information related to the user or the device, and further present the unique and non-confidential information to the user such that the information is used to verify the legitimacy of the skill. Upon a verification of the legitimacy of the skill, the user can operate the skill by voice or audio instructions.

### BACKGROUND

Always-on devices, such as Internet of things (IoT) devices, can be powered on and always connected to a network. Such always-on devices may be active all the time or most of the time. Many IoT devices may rely on voice-controlled or voice assistant applications to perform some tasks. A voice-controlled or voice assistant application can be referred to as a skill. The operations of a skill depend on accurate speech recognition for correct functionality, which may be difficult to achieve sometimes. Skill squatting is a security attack of a skill on a device. In skill squatting, an attacker leverages systematic errors to route a user to a malicious application without their knowledge. Mechanisms are desired to combat the skill squatting security attack.

### BRIEF SUMMARY

Disclosed herein are system, apparatus, device, method and/or computer program product embodiments, and/or combinations and sub-combinations thereof, for protecting a device from skill squatting by verifying the legitimacy of a skill to a user before operating the skill based on user instructions. Upon receiving an audio signal from a user to operate a skill on an always-on listening device, the skill can retrieve unique and non-confidential information related to the user or the always-on listening device, and further present the unique and non-confidential information to the user such that the information is used to verify the legitimacy of the skill. Upon a verification of the legitimacy of the skill, the user can operate the skill by voice or audio instructions. For embodiments herein, an always-on listening device can be referred to as an always-on device, a computing device, or a device.

In some examples, an always-on listening device can include a receiver and a processor coupled to the receiver. The receiver can receive an audio signal from a user. Based on the audio signal, the processor can invoke a skill on the always-on listening device from a dormant state into an active state. Afterwards, the processor can retrieve unique and non-confidential information related to the user or the always-on listening device, and present the unique and non-confidential information to the user such that the information is used to verify the legitimacy of the skill. Upon a verification of the legitimacy of the skill by the user, the always-on listening device can receive instructions from the user to operate the skill.

Descriptions provided in the summary section represent only examples of the embodiments. Other embodiments in the disclosure may provide varying scopes different from the description in the summary. In some examples, systems and computer program products of the disclosed embodiments may include a computer-readable device storing computer instructions for any of the methods disclosed herein or one or more processors configured to read instructions from the computer readable device to perform any of the methods disclosed herein.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of a system for verifying the legitimacy of a skill before operating the skill based on user instructions, according to some embodiments.

FIGS. 2-3 illustrate example processes for verifying the legitimacy of a skill before operating the skill based on user instructions, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

An always-on listening device can be an Internet of things (IoT) device connected to a network or a cloud server, while interacting with users. A skill can be a voice-controlled or voice assistant application operated on an always-on listening device. Skill squatting is a security attack of a legitimate skill on a device when an attacker leverages systematic errors to route a user to a malicious application or skill without their knowledge. In detail, an attacker can install a fraudulent skill on the device that can be triggered very similarly to a legitimate skill. The fraudulent skill can simulate the legitimate skill and use social engineering or phishing to obtain sensitive information of the user. For instance, a fraudulent skill named “Cape E Tall Won” may be installed alongside a legitimate skill named “Capital One.” When a user intends to trigger the legitimate skill Capital One but the user stutters or pronounces with an accent, the fraudulent skill Cape E Tall Won skill may be triggered instead of the legitimate skill. Since both the legitimate skill Capital One and the fraudulent skill Cape E Tall Won use the same voice synthesizer of the device, the fraudulent skill Cape E Tall Won can pretend to be the legitimate skill Capital One and phish the user information.

Embodiments herein present techniques to reduce the chance for skill squatting from happening. When a user provides an audio signal or a voice command to trigger a legitimate skill, the legitimate skill may present some unique and non-confidential information to the user such that the information is used to verify the legitimacy of the skill. Some unique and non-confidential information may be information with specific detail that is known to the user about the user, the always-on listening device, the skill, or some other related information. Such specific detail may be hard to be guessed by a fraudulent skill. However, unique and non-confidential information is different from sensitive or security information. For example, a user name, a password, a social security number of a user, or any other inform deemed to be sensitive or secure information by a person having the ordinary skills in the art would not be used as unique and non-confidential information. In some embodiments, a location can be an example of unique and non-confidential information. Before performing any operations based on user instruction, the legitimate skill can validate itself to the user using the location information, to speak to the user that “Welcome to Capital One. We see that you are in Philadelphia.” There may be many other ways for the legitimate skill to provide various unique and non-confidential information to the user to verify legitimacy of the skill, which may be described in more details below. By having the additional operations of providing various unique and non-confidential information to the user to verify the legitimacy of the skill, the chance of a fraudulent skill to obtain sensitive user information by skill squatting can be reduced. Accordingly, embodiments herein improve the security of a skill on the always-on listening device.

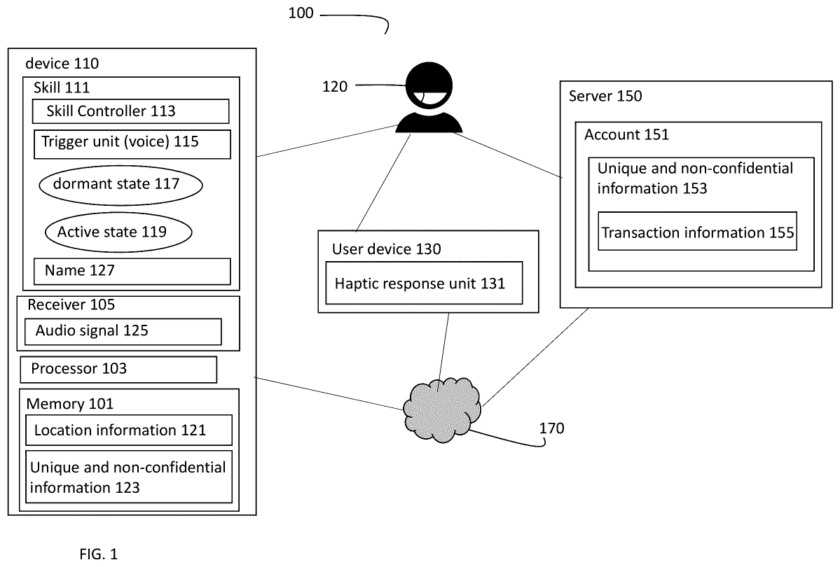

FIG. 1 is a block diagram of a system 100 according to some embodiments. For example, system 100 may be used for verifying the legitimacy of a skill 111 before operating the skill 111 based on user instructions. It is to be understood that there may be more or fewer components included in system 100. Further, it is to be understood that one or more of the devices and components within system 100 may include additional and/or varying features from the description below, and may include any devices and components that one having ordinary skill in the art would consider and/or refer to as verifying the legitimacy of a skill before operating the skill based on user instructions.

In some embodiments, system 100 can include an always-on listening device 110, a user device 130, a server 150, operatively coupled to each other through a network 170. Always-on listening device 110 can simply be referred to as device 110. In some embodiments, device 110 can include a memory 101, a processor 103, and a receiver 105 coupled to each other. Various modules, which can be implemented as hardware, software, or a combination of hardware and software can be operated on device 110. In some embodiments, skill 111, which can be a voice-controlled or voice assistant application, can be operated on device 110. User 120 can invoke skill 111 on device 110 by voice or other audio signals. User device 130 can be another device that is accessible to user 120. User 120 can access user device 130 by audio signals, voice commands, or any other access means. User device 130 can include various components such as a processor and memory (not shown), in addition to a haptic response unit 131. Similarly, server 150 can include various components such as a processor and memory (not shown).

In some embodiments, network 170 can be a “computer network” or a “communication network,” which terms are used interchangeably. In some examples, network 170 can include an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

In some embodiments, server 150 can include a server device (e.g., a host server, a web server, an application server, etc.), a data center device, or a similar device. Server 150 can include a processor, an operating system, server applications operated by the processor, and a storage device coupled to the processor. The processor of server 150 can include one or more central processing units (CPUs), and a programmable device (such as a hardware accelerator or a FPGA).

In some embodiments, device 110 can be an always-on listening device, which can be a device that can receive an audio signal or voice command. Even though device 110 can be an always-on listening device, it does not mean device 110 has to be on or operational all the time during every second of a day. Instead, device 110 can be off during some time period and can further be powered on. Device 110 can be a wireless communication device, a smart phone, a laptop, a tablet, a personal assistant, a monitor, a wearable device, an Internet of Thing (IoT) device, a mobile station, a subscriber station, a remote terminal, a wireless terminal, a video camera, an instrument, or any other user device. Device 110 can also be configured to operate based on a wide variety of wireless communication techniques. These techniques can include, but are not limited to, techniques based on 3rd Generation Partnership Project (3GPP) standards.

In some embodiments, skill 111 can have a name 127, and can be in various states, such as a dormant state 117, an active state 119, or other states. Skill 111 can be triggered by a trigger unit 115 to switch between the various states. Furthermore, skill 111 can further include a skill controller 113 to control operations of skill 111.

In some embodiments, when device 110 is on, by default, skill 111 can be in dormant state 117. When skill 111 is in dormant state 117, receiver 105 can receive an audio signal 125 from user 120. Based on audio signal 125, processor 103 can invoke skill 111 from dormant state 117 into an active state 119. Operations to invoke skill 111 from dormant state 117 into an active state 119 may be performed by skill controller 113. In some embodiments, audio signal 125 can be an explicit trigger voice message including name 127 of skill 111. For instance, the received audio signal 125 can be a command, “Capital One, what is my account balance?” Such an audio signal can invoke a legitimate skill named “Capital One” to check an account balance for an account managed by Capital One®. Skill can also be invoked implicitly. Implicit invocation occurs when user 120 instructs device 110 to perform some tasks without directly calling to a skill name. In some embodiments, skill 111 can be implicitly invoked when user 120 instructs device 110 to make a payment, which can invoke the skill Capital One to make the payment.

In some embodiments, in active state 119, skill 111 can retrieve unique and non-confidential information 123 or non-confidential information 153, and present the unique and non-confidential information to user 120 such that the unique and non-confidential information is used to verify the legitimacy of skill 111 by user 120. Upon a verification of the legitimacy of skill 111, device 110 or receiver 105 can receive instructions from user 120 to operate skill 111. On the other hand, when user 120 may have any doubt about the legitimacy of skill 111, device 110 or receiver 105 can receive further instructions from user 120 to request skill 111 to present further information to user 120, such that the further information is used to verify the legitimacy of skill 111.

In some embodiments, unique and non-confidential information 123 related to user 120 or device 110 can be stored in memory 101. Unique and non-confidential information 123 can be location information 121. Similar unique and non-confidential information 153, such as transaction information 155 related to user 120, can be saved to an account 151 on server 150 associated with user 120, device 110, or skill 111. In some embodiments, skill 111 can be linked to account 151 stored on server 150. In some embodiments, account 151 can be a financial account, and transaction information 155 can be information related to financial transactions performed by user 120 related to the financial account. Unique and non-confidential information 153 saved at account 151 of server 150 can be retrieved and saved into memory 101 to become unique and non-confidential information 123. In some embodiments, unique and non-confidential information 123 may include additional information not saved in unique and non-confidential information 153.

In some embodiments, unique and non-confidential information 123 or unique and non-confidential information 153 may be information with specific detail that is known to user 120 about user 120, device 110, skill 111, or some other related information. Such specific detail may be hard to be guessed by a fraudulent skill. However, unique and non-confidential information is different from sensitive or security information. For example, a user name, a password, a social security number of user 120, or any other inform deemed to be sensitive or secure information by a person having the ordinary skills in the art may not be used as unique and non-confidential information 123 or unique and non-confidential information 153.

In some embodiments, skill 111 can retrieve location information 121 of user 120, and speak to user 120, “Welcome to Capital One. We see that you are in Philadelphia.” The location information 121 indicates the location to be Philadelphia. In some embodiments, location information 121 can be obtained from user device 130, from device 110 dynamically, or programmed into device 110. User 120 can determine whether the location is correct or not, and further determine skill 111 is a legitimate skill or not. There can be other unique and non-confidential information 153, such as transaction information 155 associated with account 151. Skill 111 can request from server 150, the unique and non-confidential information, e.g., transaction information 155, linked to account 151, and receive a message from server 150 including the unique and non-confidential information. In some embodiments, skill 111 can retrieve transaction information 155, and speak to user 120, “We see that your last transaction was for Gas,” “was within 2 miles of your home,” or “was 9 hours ago”, etc. Such detailed and specific unique and non-confidential information 153 can allow user 120 to verify that skill 111 is a legitimate skill that can communicate with account 151 associated with user 120.

In some embodiments, there can be other ways for presenting unique and non-confidential information 123 or unique and non-confidential information 153 to user 120 such that the information is used to verify legitimacy of skill 111. Skill 111 can present a response on user device 130, which may be a smart device such as a smart watch or smart glasses different from device 110. In some embodiments, skill 111 can trigger haptic response unit 131 to generate haptic movement or a push notification by user device 130. Such haptic movements can be predetermined, which can be saved on device 110 and known to user 120. In some embodiments, such predetermined haptic movements or push notification can be saved in account 151 on server 150 linked to skill 111. Skill 111 can retrieve the saved haptic response in unique and non-confidential information 153 and generate such response on user device 130 linked to account 151. User 120 can verify that skill 111 is a legitimate skill based on the haptic response or push notification generated by user device 130.

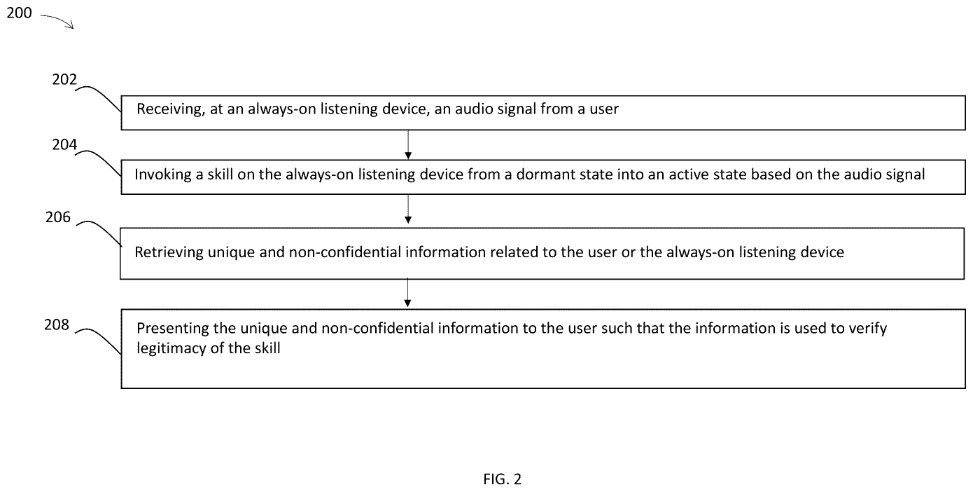

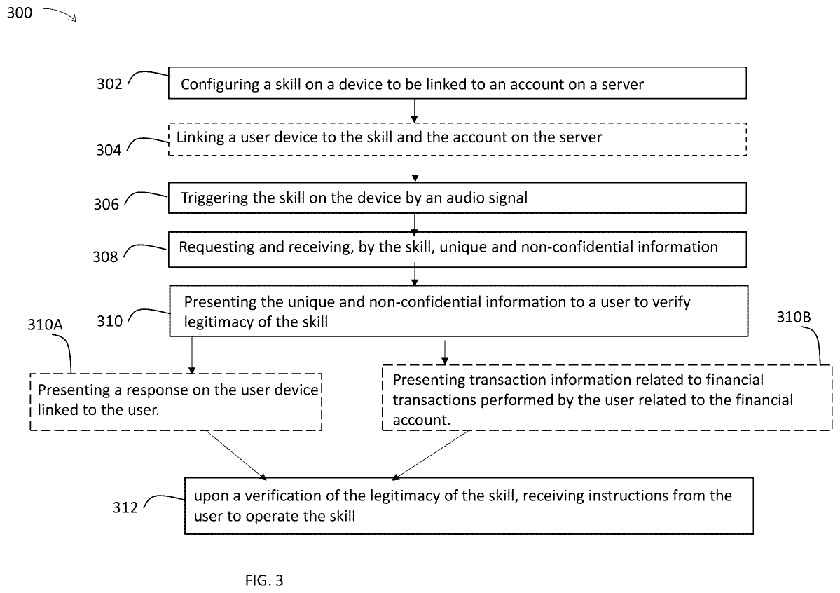

FIGS. 2-3 illustrate example processes 200 and 300, according to some embodiments. For example process 200 and/or 300 can be for verifying legitimacy of a skill before operating the skill based on user instructions. In some embodiments, process 200 and process 300 can be performed by processing logic of device 110 that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be optionally performed or performed simultaneously, or in a different order than shown in FIGS. 2-3, as will be understood by a person of ordinary skill in the art.

In one aspect, at operation 202, receiver 105 can receive audio signal 125 from user 120, which can further trigger the trigger unit 115 of skill 111.

In one aspect, at operation 204, based on the audio signal 125, skill controller 113 can invoke skill 111 from dormant state 117 into active state 119.

In one aspect, at operation 206, skill controller 113 can retrieve unique and non-confidential information related to user 120 or device 110, such as unique and non-confidential information 123 stored in memory 101, or unique and non-confidential information 153 stored in account 151 linked to skill 111.

In one aspect, at operation 208, skill controller 113 can present unique and non-confidential information 123 or unique and non-confidential information 153 to user 120 such that the information can be used to verify the legitimacy of the skill by user 120.

In some embodiments, process 300 may be performed instead of process 200.

In one aspect, at operation 302, skill 111 can be configured on device 110 to be linked to account 151 on server 150.

In one aspect, at operation 304, optionally, user device 130 can be linked to skill 111 and account 151 on server 150.

In one aspect, at operation 306, receiver 105 can receive audio signal 125 from user 120, which can further trigger the trigger unit 115 of skill 111, and skill controller 113 can invoke skill 111 from dormant state 117 into active state 119.

In one aspect, at operation 308, skill controller 113 can request and further receive unique and non-confidential information 123 or unique and non-confidential information 153.

In one aspect, at operation 310, skill controller 113 can present unique and non-confidential information to user 120 to verify legitimacy of skill 111. In some embodiments, at 310A, skill controller 113 can present a response on user device 130 that is linked to user 120. In some other embodiments, at 310B, skill controller 113 can present transaction information related to financial transactions performed by user 120 related to account 151, which can be a financial account.

In one aspect, at operation 312, upon a verification of the legitimacy of skill 111, skill controller 113 can receive instructions from user 120 to operate skill 111.

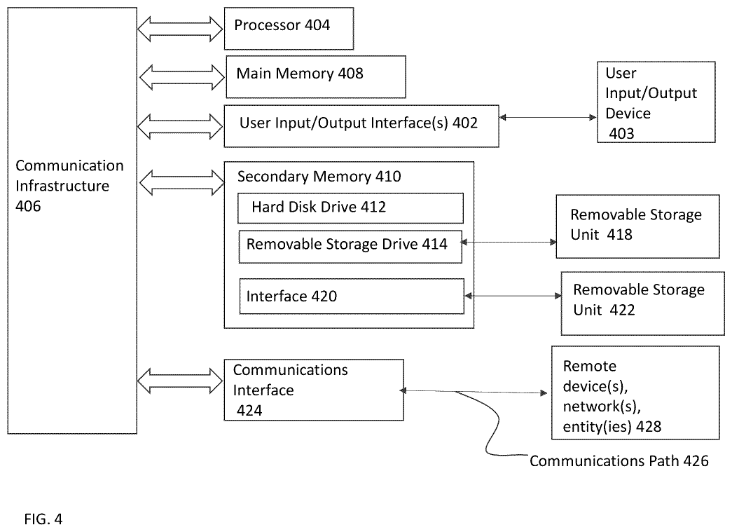

FIG. 4 shows a computer system 400, according to some embodiments. Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof. In some examples, computer system 400 can be used to implement device 110, user device 130, or server 150 as shown in FIG. 1, or operations shown in FIGS. 2-3. Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein. For example, control logic may cause processor 404 to perform operations shown in FIGS. 2-3.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections may set forth one or more but not all exemplary embodiments of the present description as contemplated by the inventor(s), and thus, are not intended to limit the present description and the appended claims in any way.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A method comprising:
receiving, at an always-on listening device, an audio signal from a user;
invoking a skill on the always-on listening device from a dormant state into an active state based on the audio signal;
retrieving unique and non-confidential information related to the user or the always-on listening device; and
presenting the unique and non-confidential information to the user such that the information is used to verify legitimacy of the skill.

2. The method of claim 1, further comprising:
upon a verification of the legitimacy of the skill, receiving instructions from the user to operate the skill.

3. The method of claim 1, wherein the presenting the unique and non-confidential information to the user comprises presenting a response on a user device that is different from the always-on listening device.

4. The method of claim 1, wherein:
the presenting the unique and non-confidential information to the user comprises presenting transaction information related to the user, and
the unique and non-confidential information is retrieved from an account stored on a server.

5. The method of claim 1, wherein the presenting the unique and non-confidential information to the user comprises presenting location information related to the user.

6. The method of claim 1, wherein the receiving the audio signal from the user comprises receiving an explicit trigger voice message including a name of the skill.

7. The method of claim 1, further comprising:
configuring the skill on the always-on listening device to be linked to an account stored on a server; and
the retrieving the unique and non-confidential information related to the user or the always-on listening device comprises retrieving the unique and non-confidential information linked to the account stored on the server.

8. The method of claim 7, wherein the retrieving the unique and non-confidential information related to the user or the always-on listening device comprises:
requesting, from the server, the unique and non-confidential information linked to the account; and
receiving a message from the server including the unique and non-confidential information.

9. The method of claim 7, wherein the presenting the unique and non-confidential information to the user comprises presenting a haptic response on a user device linked to the account.

10. The method of claim 7, wherein:
the account is a financial account, and
the retrieving the unique and non-confidential information comprises retrieving information related to financial transactions performed by the user related to the financial account.

11. The method of claim 1, further comprising:
receiving instructions from the user to request the skill to present further information to the user, such that the further information is used to verify the legitimacy of the skill.

12. A non-transitory computer-readable medium storing instructions, the instructions, when executed by a processor of an always-on listening device, cause the processor to perform operations comprising:
receiving an audio signal from a user by the always-on listening device;
invoking a skill operated by the always-on listening device from a dormant state into an active state based on the audio signal;
retrieving unique and non-confidential information related to the user or the always-on listening device; and
presenting the unique and non-confidential information to the user such that the information is used to verify legitimacy of the skill.

13. The non-transitory computer-readable medium of claim 12, wherein the instructions, when executed by the processor, cause the processor to perform further operations comprising:
upon a verification of the legitimacy of the skill, receiving instructions from the user to operate the skill.

14. The non-transitory computer-readable medium of claim 12, wherein the presenting the unique and non-confidential information to the user comprises presenting a response on a user device that is different from the always-on listening device.

15. The non-transitory computer-readable medium of claim 12, wherein:
the presenting the unique and non-confidential information to the user comprises presenting transaction information related to the user, and
the unique and non-confidential information is retrieved from an account stored on a server.

16. The non-transitory computer-readable medium of claim 12, wherein the presenting the unique and non-confidential information to the user comprises presenting a location information related to the user.

17. The non-transitory computer-readable medium of claim 12, wherein the receiving the audio signal from the user comprises receiving an explicit trigger voice message including a name of the skill.

18. An always-on listening device, comprising:
a receiver configured to receive an audio signal from a user;
a processor coupled to the receiver and configured to:
invoke a skill on the always-on listening device from a dormant state into an active state based on the audio signal;
retrieve unique and non-confidential information related to the user or the always-on listening device; and
present the unique and non-confidential information to the user such that the information is used to verify legitimacy of the skill.

19. The always-on listening device of claim 18, wherein the processor is further configured to:
upon a verification of the legitimacy of the skill, receive instructions from the user to operate the skill.

20. The always-on listening device of claim 18, wherein to present the unique and non-confidential information to the user, the processor is configured to present a response on a user device that is different from the always-on listening device.
